(19) United States
(12) Patent Application Publication
(10) Pub. No.: US 2011/0307563 A1
(43) Pub. Date: Dec. 15, 2011

(54) DETERMINING GROUP CHAT ACCESS

(75) Inventor: Lisa Seacat DeLuca, San Francisco, CA (US)

(73) Assignee: International Business Machines Corporation, Armonk, NY (US)

(21) Appl. No.: 12/815,508

(22) Filed: Jun. 15, 2010

(51) Int. Cl. G06F 15/16; G06F 15/173

(52) U.S. Cl. 709/206; 709/204; 709/225

(57) ABSTRACT

A method and computer program product for determining group chat access is described. A method may comprise sending a passphrase for a group chat from a first user to a second user. The method may further comprise determining a level of the second user for the group chat based upon, at least in part, a number of group chat participants between the second user and a moderator through which the second user was informed of the passphrase for the group chat. The method may also comprise determining if the first user is permitted to access the group chat based upon, at least in part, a user-level set by the moderator and the level of the second user for the group chat. The method may additionally comprise, if the first user is permitted to access the group chat, allowing the first user to access the group chat.

### BACKGROUND OF THE INVENTION

This disclosure relates to determining group chat access and, more particularly, to methodologies for existing group chat participants to allow new group chat participants to access the group chat using a common passphrase.

Group chats may allow one or more existing group chat participants (i.e., those already in the group chat) to manually add new group chat participants (i.e., those not currently in the group chat) to the group chat. If there are large numbers of individuals who need to participate in the group chat, these manual additions of new group chat participants may be cumbersome. Accordingly, there may be a need to improve ways to allow new group chat participants to join a group chat.

### BRIEF SUMMARY OF THE INVENTION

In a first embodiment, a method may comprise, sending, via at least one of a client electronic device and a server computer, a passphrase for a group chat from a first user to a second user. The method may further comprise determining, via at least one of the client electronic device and the server computer, a level of the second user for the group chat based upon, at least in part, a number of group chat participants between the second user and a moderator through which the second user was informed of the passphrase for the group chat. The method may also comprise, determining, via at least one of the client electronic device and the server computer, if the first user is permitted to access the group chat based upon, at least in part, a user-level set by the moderator and the level of the second user for the group chat. The method may additionally comprise, if the first user is permitted to access the group chat, allowing, via at least one of the client electronic device and the server computer, the first user to access the group chat.

One or more of the following features may be included. It may be determined if the second user is a group chat participant. If the second user is not a group chat participant, the first user may be prevented from accessing the group chat. The level of the second user may be determined based upon, at least in part, a tree structure. The tree structure may describe the number of group chat participants between the second user and the moderator through which the second user was informed of the passphrase for the group chat.

In some implementations, the method may further comprise changing the passphrase for the group chat and removing a group chat participant. The method may also comprise changing the passphrase for the group chat without removing a group chat participant. The first user may be permitted access to only one group chat if more than one group chats share the same passphrase. The passphrase may be set by the moderator and distributed to at least one group chat participant. The passphrase for the group chat may be sent from the first user to the second user via instant message. If the first user is allowed access to the group chat, the passphrase sent from the first user to the second user may not be displayed to the second user. The moderator may be able to remove any group chat participant from the group chat.

In second embodiment, a computer program product may reside on a computer readable storage medium and may have a plurality of instructions stored on it. When executed by a processor, the instructions may cause the processor to perform operations comprising, sending a passphrase for a group chat from a first user to a second user. The operations may further comprise determining a level of the second user for the group chat based upon, at least in part, a number of group chat participants between the second user and a moderator through which the second user was informed of the passphrase for the group chat. The operations may also comprise, determining if the first user is permitted to access the group chat based upon, at least in part, a user-level set by the moderator and the level of the second user for the group chat. The operations may additionally comprise, if the first user is permitted to access the group chat, allowing the first user to access the group chat.

One or more of the following features may be included. It may be determined if the second user is a group chat participant. If the second user is not a group chat participant, the first user may be prevented from accessing the group chat. The level of the second user may be determined based upon, at least in part, a tree structure. The tree structure may describe the number of group chat participants between the second user and the moderator through which the second user was informed of the passphrase for the group chat.

In some implementations, the operations may further comprise changing the passphrase for the group chat and removing a group chat participant. The operations may also comprise changing the passphrase for the group chat without removing a group chat participant. The first user may be permitted access to only one group chat if more than one group chats share the same passphrase. The passphrase may be set by the moderator and distributed to at least one group chat participant. The passphrase for the group chat may be sent from the first user to the second user via instant message. If the first user is allowed access to the group chat, the passphrase sent from the first user to the second user may not be displayed to the second user. The moderator may be able to remove any group chat participant from the group chat.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a group chat access process coupled to a distributed computing network;

FIG. 2 is a flowchart of the group chat access process of FIG. 1;

FIG. 3 is an instant message flow which may be associated with the group chat access process of FIG. 1;

FIG. 4 is tree structure which may be associated with the group chat access process of FIG. 1;

FIG. 5 is popup window which may be associated with the group chat access process of FIG. 1; and

FIG. 6 is chat window which may be associated with the group chat access process of FIG. 1.

### DETAILED DESCRIPTION OF THE INVENTION

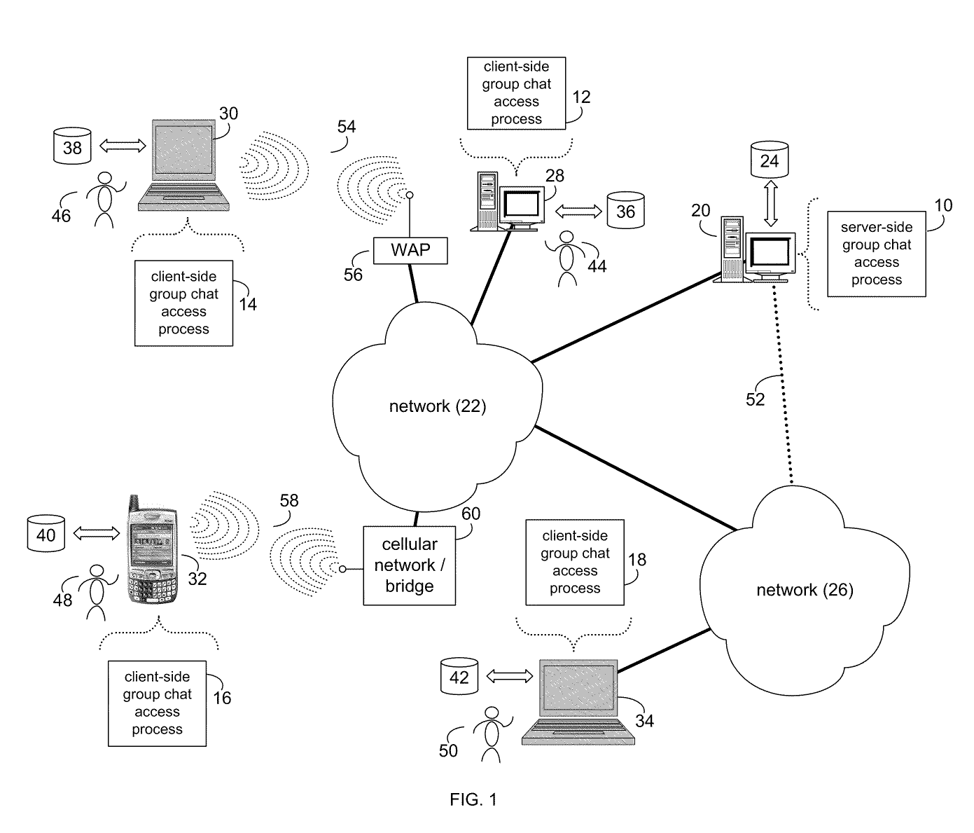

Referring to FIGS. 1 & 2, there is shown a group chat access process 10. As will be discussed below, group chat access process 10 may send 100 a passphrase for a group chat from a first user to a second user. Group chat access process may further determine 102 a level of the second user for the group chat based upon, at least in part, a number of group chat participants between the second user and a moderator through which the second user was informed of the passphrase for the group chat.

The group chat access (GCA) process may be a server-side process (e.g., server-side GCA process 10), a client-side process (e.g., client-side GCA process 12, client-side GCA process 14, client-side GCA process 16, or client-side GCA process 18), or a hybrid server-side/client-side process (e.g., the combination of server-side GCA process 10 and one or more of client-side GCA processes 12, 14, 16, 18).

Server-side GCA process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and/or a mainframe computer. Server computer 20 may be a web server (or a series of servers) running a network operating system, examples of which may include but are not limited to: Microsoft® Windows Server®; Novell® Netware®; or Red Hat® Linux®, for example.

The instruction sets and subroutines of server-side GCA process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft® IIS, Novell® Web Server, or Apache® Web Server, that allows for access to server computer 20 (via network 22) using one or more protocols, examples of which may include but are not limited to HTTP (i.e., HyperText Transfer Protocol), SIP (i.e., session initiation protocol), and the Lotus® Sametime® VP protocol. Network 22 may be connected to one or more secondary networks (e.g., network 26), examples of which may include but are not limited to: a local area network; a wide area network; or an intranet, for example.

Client-side GCA processes 12, 14, 16, 18 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 22 and/or network 26 and may each execute an operating system, examples of which may include but are not limited to Microsoft® Windows®, Microsoft Windows CE®, Red Hat® Linux®, or a custom operating system.

The instruction sets and subroutines of client-side GCA processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side GCA processes 12, 14, 16, 18 and/or server-side GCA process 10 may be processes that run within (i.e., are part of) a group chat and/or instant messaging application. Alternatively, client-side GCA processes 12, 14, 16, 18 and/or server-side GCA process 10 may be stand-alone applications that work in conjunction with the group chat and/or instant messaging application. One or more of client-side GCA processes 12, 14, 16, 18 and server-side GCA process 10 may interface with each other (via network 22 and/or network 26) to allow a plurality of users (e.g., users 44, 46, 48, 50) to share information. In one implementation client-side GCA processes 12, 14, 16, 18 and/or server-side GCA process 10 may be processes that run within or in connection with a unified communications and collaboration application, including but not limited to Lotus® Sametime®.

Users 44, 46, 48, 50 may access server-side GCA process 10 directly through the device on which the client-side GCA process (e.g., client-side GCA processes 12, 14, 16, 18) is executed, namely client electronic devices 28, 30, 32, 34, for example. Users 44, 46, 48, 50 may access server-side GCA process 10 directly through network 22 and/or through secondary network 26. Further, server computer 20 (i.e., the computer that executes server-side GCA process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, Wi-Fi, and/or Bluetooth device that is capable of establishing wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Group Chat Access Process

GCA process 10 may allow a user and/or moderator to create a group chat amongst existing participants. Those individuals who are already in the group chat may accept new group chat participants using a common keyword and/or passphrase. For the following discussion, server-side GCA process 10 will be described for illustrative purposes. Client-side GCA process 12 may be incorporated into server-side GCA process 10 and may be executed within one or more applications that allow for communication with client-side GCA process 12. However, this is not intended to be a limitation of this disclosure, as other configurations are possible (e.g., stand-alone, client-side GCA processes and/or stand-alone server-side GCA processes.) For example, some implementations may include one or more of client-side GCA processes 14, 16, 18 in place of or in addition to client-side GCA process 12.

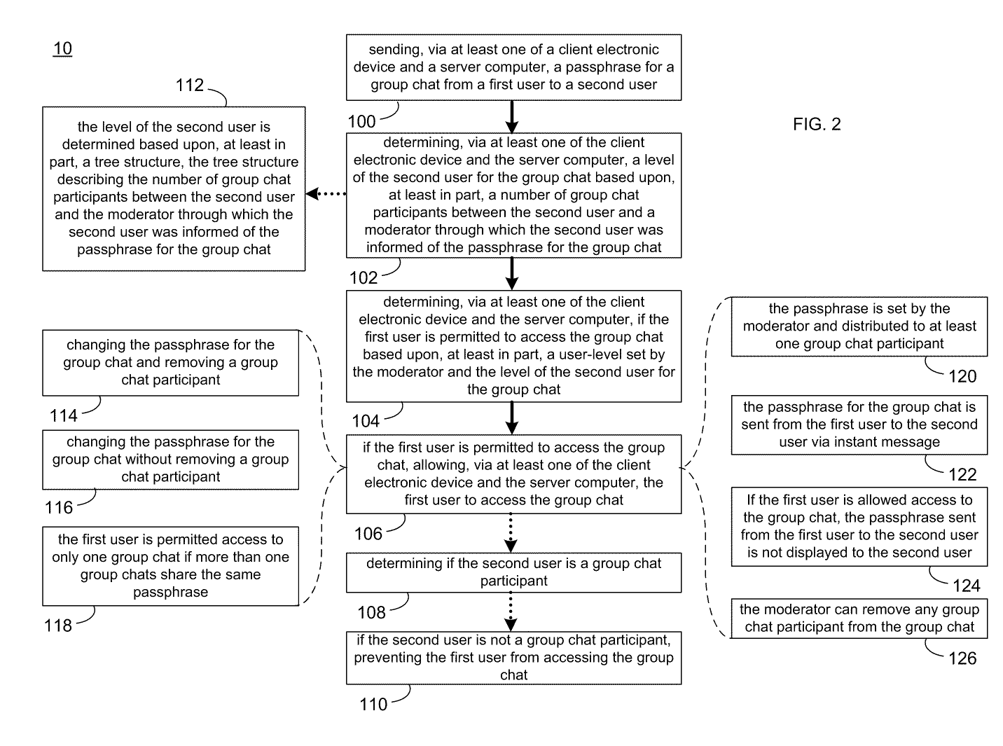

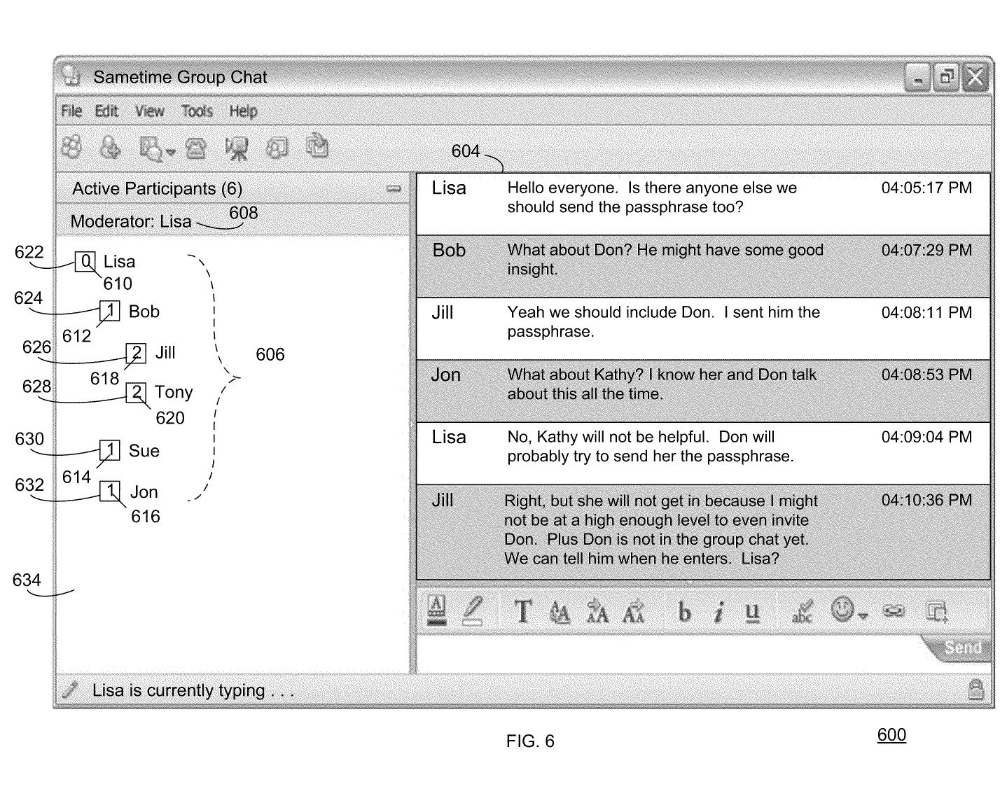

Referring now to FIGS. 1-6, GCA process 10 may send 100 passphrase 302 for group chat (e.g., group chat 600) from first user 304 (e.g., Bob) to second user 306 (e.g., Lisa). As shown in FIG. 6, group chat 600 may be shown in a conventional chat window and may include a number of group chat participants (e.g., group chat participants 600 shown in participant list 602). Further, chat messages between participants may be shown in chat pane 604. First user 304 and second user 306 may both be users of a common group chat and/or instant messaging application. Further, first user 304 and second user 306 may both be users of a unified communications and collaboration application, as discussed above. GCA process 10 may further determine 102 level 610 of second user 306 for group chat 600 based upon, at least in part, a number of group chat participants between second user 306 and moderator 608 through which second user 306 was informed of passphrase 302 for group chat 600. Level 610 may be shown in level indicator box 622.

For example, assume for illustrative purposes that both second user 306 and moderator 608 are Lisa. Since Lisa is the moderator, her level (e.g., level 610) for group chat 600 is “0”. In other words, the number of group chat participants between second user 306, Lisa in this example, and moderator 608, also Lisa in this example, through which second user 306 was informed of passphrase 302 for group chat 600 is “0”. Further by way of example, assume for illustrative purposes that the second user is Bob (e.g., second user 310), and that moderator 608 is again Lisa. Since second user 310, Bob in this example, was informed of passphrase 302 from Lisa, Bob's level (e.g., level 612) for group chat 600 is “1”. In other words, the number of group chat participants between second user 310, Bob in this example, and moderator 608, Lisa in this example, through which second user 310 (Bob) was informed of passphrase 302 for group chat 600 is “1”. Level 612 may be shown in level indicator box 624, respectively.

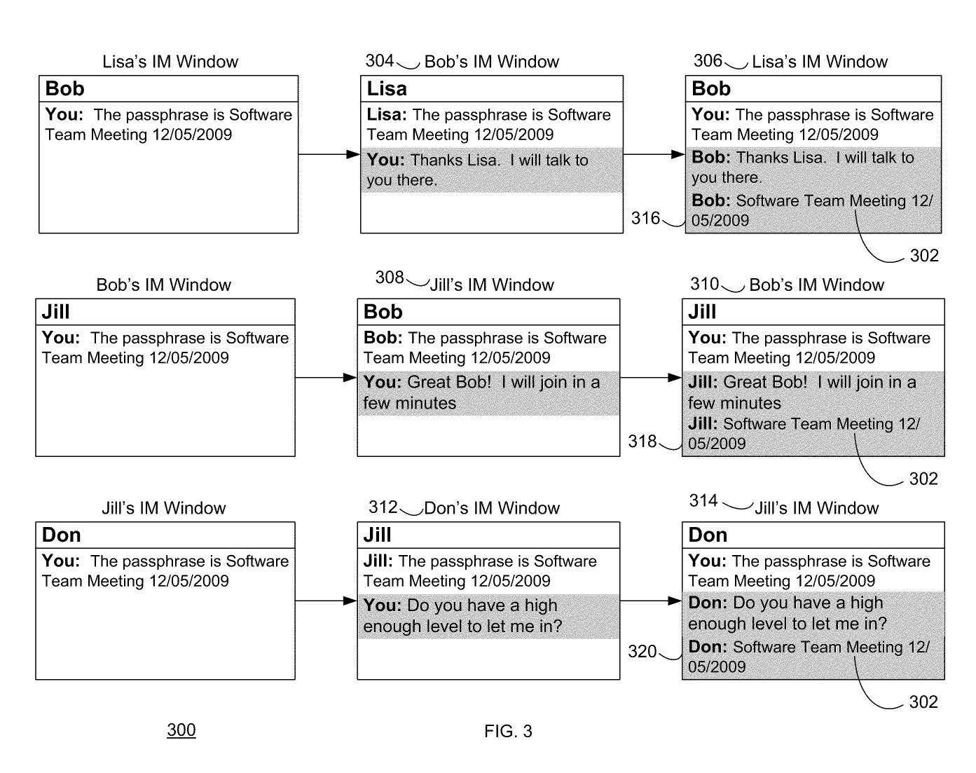

As shown in FIG. 3, passphrase 302 may be sent (122) via instant message (IM). Passphrase 302 for group chat 600 may be sent from the first user (e.g., first user 304) to the second user (e.g., second user 306) via IM. GCA process 10 may parse each IM sent in order to find a passphrase (e.g., passphrase 302) known to exist for a group chat (e.g., group chat 600). Once GCA process 10 finds that a passphrase (e.g., passphrase 302) has been sent from someone not in a group chat (e.g., group chat 600) to someone that is in a group chat (e.g., group chat 600), GCA process 10 may determine whether or not the sender is permitted to access the group chat (e.g., group chat 600). While passphrase 302 is shown as being displayed in IM windows 316, 318, and 320, passphrase 302 may not always be displayed in the IM window of the second user (e.g., second users 306, 310, and 314). For example, of the first user (e.g., first user 304) is allowed access to the group chat (e.g., group chat 600), passphrase 302 sent from first user 304 to second user 306 may not (124) be displayed to second user 306. In other words, GCA process 10 may automatically allow access to first user 304 without showing the IM of passphrase 302 in second user 306's IM window. However, in one implementation, if the receiver (e.g., second user 306) passphrase 302 is not in the group chat (e.g., group chat 606), and the sender (e.g., first user 304) is not permitted to access the group chat (e.g., group chat 606), passphrase 302 may be displayed to second user 306 as sent from first user 304.

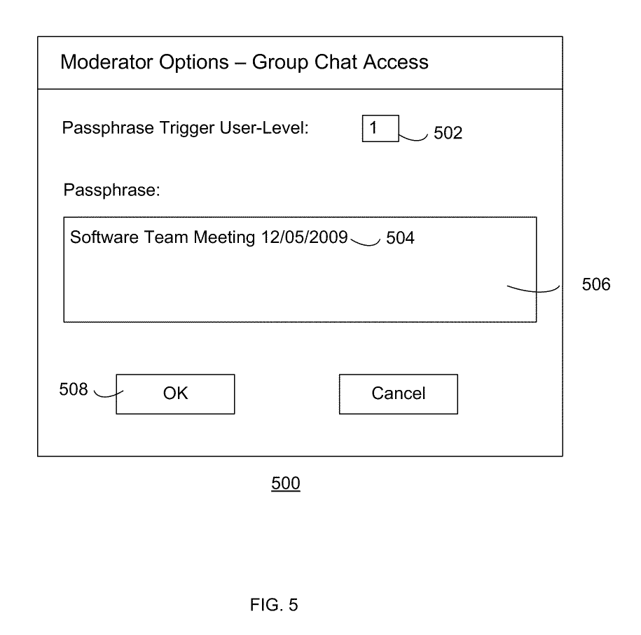

Continuing with the first example, GCA process 10 may determine 104 if first user 304 (e.g., Bob) is permitted to access group chat 600 based upon, at least in part, user-level 502 set by moderator 608 and level 610 of second user 306 (e.g., Lisa) for group chat 600. Moderator 608 may access popup window 500 from group chat 600, or otherwise from the group chat, instant messaging, and/or unified communications and collaboration application. Moderator 608 may select user-level 502 such that group chat participants of only a certain level or lower may allow access to those not currently in group chat 600. As shown in FIG. 5, moderator 608 may set user-level 502 to “1”. In other words, if second user 306 has a level for group chat 600 that is “1” or lower, second user 306 may allow access to those not currently in group chat 600.

Further, moderator 608 may set (120) the passphrase (e.g., passphrase 504). Passphrase 504 may be entered in text box 506 and may be set by selecting “ok” button 508. Passphrase 504 may be distributed to at least one group chat participant (e.g., one or more of group chat participants 606). Passphrase 504 may be distributed to one or more of group chat participants 606 before they have gained access to group chat 600. In this way, each participant may be notified of the passphrase from someone already participating in the chat, beginning with the moderator.

Continuing with the above example, second user 306 (e.g., Lisa) may allow first user 304 (e.g., Bob), to have access to group chat 600. As shown in FIG. 3, Lisa may do so by sending Bob passphrase 302. As further shown in FIG. 3, in order to gain access to group chat 600, Bob may send passphrase 302 to Lisa via an IM. In this example, GCA process 10 may determine 104 that Bob is permitted to access group chat 600 since user-level 502 is set to “1”, and since the group chat participant that he sent the passphrase (e.g., passphrase 302) to, second user 306 or Lisa, has a level (e.g., level 610) for group chat 600 of “1”. If first user 304 (e.g., Bob) is permitted to access group chat 600, GCA process 10 may allow 106 first user 304 (e.g., Bob) to access group chat 600.

While in this example GCA process 10 may determine that those with a level for group chat 600 that is “1” or lower may allow access to those not currently in group chat 600, other configurations are possible. For example, in some implementations only those with a level for group chat 600 that is exactly user-level 502 (e.g., “1”) may allow access to those not currently in group chat 600. Further, those with a level for group chat 600 that is user level 502 (e.g., “1”) or higher may allow access to those not currently in group chat 600.

In another example, assume the first user is first user 308 (e.g., Jill) and that the second user is second user 310 (e.g., Bob), and that Jill sends passphrase 302 to Bob via IM. In this example, Jill may be allowed access to group chat 600 because Bob's level (e.g., level 612) for group chat 600 is level “1”, as shown in FIG. 6, and user-level 502 as shown in FIG. 5 is set to “1”. In still another example, assume the first user is first user 312 (e.g., Don), and that the second user is second user 314 (e.g, Jill), and that Don sends passphrase 302 to Jill via IM. In this example, Don may not be allowed access to group chat 600 because Jill's level (e.g., level 618) for group chat 600 is level “2” as shown in FIG. 6, and user-level 502 as shown in FIG. 5 is set to “1”. Jill's level for group chat 600 may be level “2” because she was informed of passphrase 302 from Bob, who was in turn informed from Lisa. Level 618 may be shown in level indicator box 626.

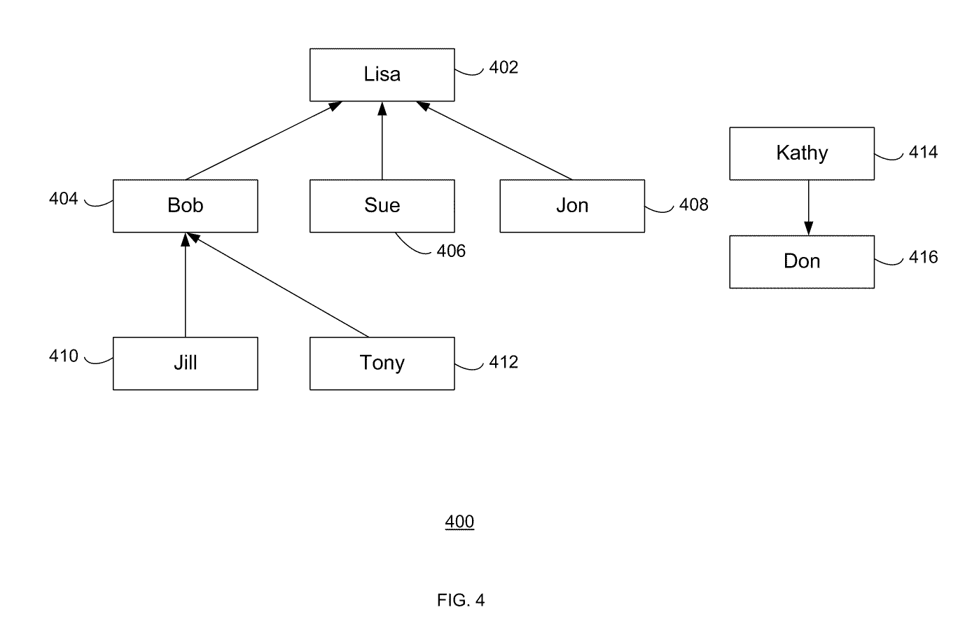

GCA process 10 may determine 108 if the second user (e.g., second user 306) is a group chat participant (e.g., one of group chat participants 606). If the second user (e.g., second user 306) is not a group chat participant (e.g., not one of group chat participants 606), GCA process 10 may prevent 110 the first user (e.g., first user 304) from accessing group chat 600. For example, and referring now also to FIG. 4, assume for illustrative purposes that the second user is Don (e.g., user 416). Further, assume that the first user is Kathy (e.g., user 414), and that Kathy sent the passphrase (e.g., passphrase 302) to Don in order to gain access to group chat 600. Since Don is not a group chat participant (e.g., not one of group chat participants 606), GCA process 10 may prevent 110 Kathy from accessing group chat 600.

In one implementation, the level (e.g., level 610) of the second user (e.g., second user 306) may be determined (112) based upon, at least in part, a tree structure (e.g., tree structure 400), the tree structure (e.g., tree structure 400) describing the number of group chat participants (e.g., group chat participants 606) between the second user (e.g., second user 306) and the moderator (e.g., moderator 608) through which the second user (e.g., second user 306) was informed of the passphrase (e.g., passphrase 302) for the group chat (e.g., group chat 600). As shown in FIG. 4, group chat participants 606 may be shown in tree structure 400. The moderator level may be referred to as level “0”, as discussed above, and may include moderator 608 (i.e., user 402 or Lisa). Those who are directly informed of the passphrase (e.g., passphrase 302) from a level “0” participant may be in level “1” (e.g., user 404 or Bob, user 406 or Sue, and user 408 or Jon, shown as levels 612, 614, and 616, respectively, in FIG. 6). Further, those who are informed of the passphrase (e.g., passphrase 302) from a level “1” participant may be in level “2” (e.g., user 410 or Jill and user 412 or Tony, shown as levels 618 and 620, respectively, in FIG. 6). Levels 612, 614, 616, 618, and 620, respectively, may be shown in level indicator boxes 624, 630, 632, 622, and 628, respectively.

As can be seen from FIG. 4, user 402 (i.e., Lisa) may share passphrase 302 for group chat 600 with user 404 (i.e., Bob), user 406 (i.e., Sue), and user 408 (i.e., Jon). Further, user 404 (i.e., Bob) may share passphrase 302 with user 410 (i.e., Jill) and user 412 (i.e., Tony). Additionally, user 416 (i.e., Don) may share passphrase 302 with user 414 (i.e., Kathy). Bob may wish to join group chat 600, and therefore may send passphrase 302 to Lisa. Since Lisa is in group chat 600, Bob may now be included in group chat 600, as may Sue and Jon if they send passphrase 302 to Lisa. In one implementation, GCA process 10 may present the moderator (e.g., Lisa) with an accept/reject message asking if it is ok for Bob to join. Jill may send the passphrase to Bob. Since Bob is already in group chat 600, Jill may also gain access, as may Tony if he sends passphrase 302 to Bob. Kathy may send the passphrase to Don. Since Don is not in group chat 600, Kathy may be denied access to group chat 600.

GCA process 10 may further change 114 the passphrase (e.g., passphrase 302) for the group chat (e.g., group chat 600) and may remove a group chat participant (e.g., one or more of group chat participants 606). For example, moderator 608 may access popup window 500 and may enter in text box 506 a new passphrase (e.g., passphrase 504). Upon selection of “ok” button 508, GCA process 10 may change 114 the passphrase, and may remove one or more group chat participants that may have used a previous passphrase to enter group chat 600. Further, GCA process 10 may change 116 the passphrase (e.g., passphrase 302) for the group chat (e.g., group chat 600) without removing a group chat participant (e.g., one or more of group chat participants 606). GCA process 10 may also change the passphrase (e.g., passphrase 302) for the group chat (e.g., group chat 600) while removing some group chat participants, and not removing other group chat participants, based upon, at least in part, the participant's level for the group chat. Moderator 608 may control which level of participants are removed, if any, upon changing of the passphrase, from popup window 500. Further, moderator 608 may remove 126 any group chat participant (e.g., one or more of group chat participants 606).

In some situations, it may be possible that multiple group chats share the same passphrase. In this situation, the first user (e.g., first user 304) may be permitted (118) access to only one group chat if more than one group chats share the same passphrase. Further, it may be possible that the passphrase chosen is a common word such as “the”. In this case, an accidental request to enter a group chat may be more likely, and the user may be required to also use an indicator word such as “join” when sending the passphrase to a group chat participant. The passphrase may be sent as “join the” in this situation.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

What is claimed is:

1. A method comprising:
sending, via at least one of a client electronic device and a server computer, a passphrase for a group chat from a first user to a second user;
determining, via at least one of the client electronic device and the server computer, a level of the second user for the group chat based upon, at least in part, a number of group chat participants between the second user and a moderator through which the second user was informed of the passphrase for the group chat;
determining, via at least one of the client electronic device and the server computer, if the first user is permitted to access the group chat based upon, at least in part, a user-level set by the moderator and the level of the second user for the group chat; and
if the first user is permitted to access the group chat, allowing, via at least one of the client electronic device and the server computer, the first user to access the group chat.

2. The method of claim 1, further comprising:
determining if the second user is a group chat participant; and
if the second user is not a group chat participant, preventing the first user from accessing the group chat.

3. The method of claim 1, wherein the level of the second user is determined based upon, at least in part, a tree structure, the tree structure describing the number of group chat participants between the second user and the moderator through which the second user was informed of the passphrase for the group chat.

4. The method of claim 1, further comprising:
changing the passphrase for the group chat and removing a group chat participant.

5. The method of claim 1, further comprising:
changing the passphrase for the group chat without removing a group chat participant.

6. The method of claim 1, wherein the first user is permitted access to only one group chat if more than one group chats share the same passphrase.

7. The method of claim 1, wherein the passphrase is set by the moderator and distributed to at least one group chat participant.

8. The method of claim 1, wherein the passphrase for the group chat is sent from the first user to the second user via instant message.

9. The method of claim 1, wherein if the first user is allowed access to the group chat, the passphrase sent from the first user to the second user is not displayed to the second user.

10. The method of claim 1, wherein the moderator can remove any group chat participant from the group chat.

11. A computer program product residing on a computer readable storage medium having a plurality of instructions stored thereon, which, when executed by a processor, cause the processor to perform operations comprising:
sending a passphrase for a group chat from a first user to a second user;
determining a level of the second user for the group chat based upon, at least in part, a number of group chat participants between the second user and a moderator through which the second user was informed of the passphrase for the group chat;
determining if the first user is permitted to access the group chat based upon, at least in part, a user-level set by the moderator and the level of the second user for the group chat; and
if the first user is permitted to access the group chat, allowing the first user to access the group chat.

12. The computer program product of claim 11, further comprising instructions for:
determining if the second user is a group chat participant; and
if the second user is not a group chat participant, preventing the first user from accessing the group chat.

13. The computer program product of claim 11, wherein the level of the second user is determined based upon, at least in part, a tree structure, the tree structure describing the number of group chat participants between the second user and the moderator through which the second user was informed of the passphrase for the group chat.

14. The computer program product of claim 11, further comprising instructions for:
changing the passphrase for the group chat and removing a group chat participant.

15. The computer program product of claim 11, further comprising instructions for:
changing the passphrase for the group chat without removing a group chat participant.

16. The computer program product of claim 11, wherein the first user is permitted access to only one group chat if more than one group chats share the same passphrase.

17. The computer program product of claim 11, wherein the passphrase is set by the moderator and distributed to at least one group chat participant.

18. The computer program product of claim 11, wherein the passphrase for the group chat is sent from the first user to the second user via instant message.

19. The computer program product of claim 11, wherein if the first user is allowed access to the group chat, the passphrase sent from the first user to the second user is not displayed to the second user.

20. The computer program product of claim 11, wherein the moderator can remove any group chat participant from the group chat.
